(19) United States
(12) Patent Application Publication
(10) Pub. No.: US 2026/0204194 A1
(43) Pub. Date: Jul. 16, 2026

(54) DISPLAY DRIVING CIRCUIT, DISPLAY DEVICE INCLUDING THE SAME, AND TEST SYSTEM FOR TESTING THE DISPLAY DEVICE

(71) Applicant: Samsung Electronics Co., Ltd., Suwon-si (KR)

(72) Inventors: Juhyeong JIN, Suwon-si (KR); SeungUk BAEK, Suwon-si (KR); Jaewon CHOI, Suwon-si (KR); Jihoon KIM, Suwon-si (KR); Kyung-Sang CHO, Suwon-si (KR)

(73) Assignee: Samsung Electronics Co., Ltd., Suwon-si (KR)

(21) Appl. No.: 19/445,029

(22) Filed: Jan. 9, 2026

(30) Foreign Application Priority Data
Jan. 13, 2025 (KR) 10-2025-0004934
May 19, 2025 (KR) 10-2025-0064686

(51) Int. Cl. G09G 3/00; G09G 3/36

(52) U.S. Cl. CPC G09G 3/006; G09G 3/3688; G09G 2300/0408; G09G 2330/12

(57) ABSTRACT

According to some example embodiments, a display driving circuit comprises includes a source driver including a plurality of source amplifiers configured to generate channel signals, a switching circuit including a plurality of switches and connected to the source driver, the plurality of switches being configured to output the channel signals as a test result, and a driving controller configured to receive a test command including parameter information indicating a test target switch range among the plurality of switches and timing conditions to perform a test, and generate a test signal that is configured to control the plurality of switches based on the test command.

### CROSS-REFERENCE TO RELATED APPLICATIONS

This U.S. non-provisional application claims priority under 35 U.S.C. § 119 to Korean Patent Application No. 10-2025-0004934 filed with the Korean Patent Office on Jan. 13, 2025, and Korean Patent Application No. 10-2025-0064686 filed with the Korean Patent Office on May 19, 2025, the entire contents of both these applications are incorporated herein by reference.

### BACKGROUND

Some example embodiments of the present disclosure relate to a display driving circuit, a display device including the same, and a test system for testing the display device.

As technology progresses, it is advantageous to reduce a size and power consumption of display driving chips. Display driving chips perform a variety of functions, and consequently, the number of functions to test increases. It is beneficial to reduce the overall test time of the display driving chips.

Test pins may be used to test a display device including the display driving chip. As the internal functions of a source driver of the display driving chip become more complex, different tests are performed on the source driver using separate pins for a control signal or an output signal for each test. Testing through a plurality of pins may increase the chip's external size, complexity, and the costs of testing. It is beneficial to perform tests while reducing the number of pins.

### SUMMARY

A display device, according to some example embodiments, is configured to perform tests according to different package types.

A display device, according to some example embodiments, is configured to reduce the number of pins used when performing a test.

A display device, according to some example embodiments, is configured to reduce the time required when performing a test.

According to some example embodiments, a display driving circuit comprises a source driver comprising a plurality of source amplifiers configured to generate channel signals, a switching circuit including a plurality of switches and connected to the source driver, the plurality of switches being configured to output the channel signals as a test result, and a driving controller configured to receive a test command including parameter information indicating a test target switch range among the plurality of switches and timing conditions to perform a test, and generate a test signal that is configured to control the plurality of switches based on the test command.

According to some example embodiments, a display device comprises a source driver comprising a plurality of output switches and a plurality of source amplifiers configured to generate channel signals, a switching circuit including a plurality of connection switches, and connected to the source driver and configured to output the channel signals as a test result, each output switch of the plurality of output switches includes a first end connected to an output terminal of a corresponding source amplifier of the plurality of source amplifiers, and a second end connected to a first end of a corresponding connection switch of the plurality of connection switches, and a driving controller configured to receive a test command including parameter information indicating a test target switch range among the plurality of output switches and the plurality of connection switches, and timing conditions to perform a test, and generate a test signal to control the plurality of output switches and the plurality of connection switches based on the test command.

According to some example embodiments, a test system comprises a test device configured to generate a test clock; and a display device configured to receive the test clock and configured to use the test clock as a reference for operating timing when the display device performs a test, the display device including a plurality of switches connected to a plurality of source amplifiers and configured to generate channel signals, and the display device being configured to receive a test command including parameter information indicating a test target switch range and timing conditions to perform the test, generate a test signal that is configured to control the plurality of switches based on the test command, and output the channel signals as a test result.

### BRIEF DESCRIPTION OF THE DRAWINGS

FIG. 1 is a diagram illustrating a display test system.

FIG. 2 is a drawing illustrating a display device according to some example embodiments.

FIG. 3 is a diagram illustrating a driving controller according to some example embodiments.

FIG. 4 is a diagram illustrating matching data according to some example embodiments.

FIG. 5 is a diagram illustrating a part of a display device according to some example embodiments.

FIG. 6 is a diagram illustrating the operation timing of a display device according to some example embodiments.

FIG. 7 is a diagram illustrating the output signal of the source amplifier when the short-circuit prevention period is not set.

FIG. 8 is a diagram illustrating an output signal of a source amplifier when a short-circuit prevention period is set according to some example embodiments.

FIG. 9 is a diagram illustrating the output signal of the source amplifier when the amplifier settling period is not set.

FIG. 10 is a diagram illustrating data voltage according to the operation of the output switch.

FIG. 11 is a diagram illustrating a display system according to some example embodiments.

### DETAILED DESCRIPTION OF EXAMPLE EMBODIMENTS

Hereinafter, embodiments of the present invention will be described in detail with reference to the accompanying drawings so that they can be easily implemented by those of ordinary skill in the art to which the present invention pertains. However, the present invention may be embodied in many different forms and should not be construed as limited to the embodiments set forth herein.

In the drawings, parts unrelated to the description are omitted to clearly describe the present invention, and similar reference numerals are assigned to similar parts throughout the specification. In the flowcharts described with reference to the drawings, the order of operations may be changed, several operations may be merged, some operations may be split, and certain operations may not be performed.

Additionally, expressions written in the singular may be interpreted as singular or plural, unless explicit expressions such as “one” or “single” are used. Terms that include ordinal numbers, such as first, second, etc., may be used to describe various components, but the components are not limited by these terms. These terms may be used to distinguish one component from another.

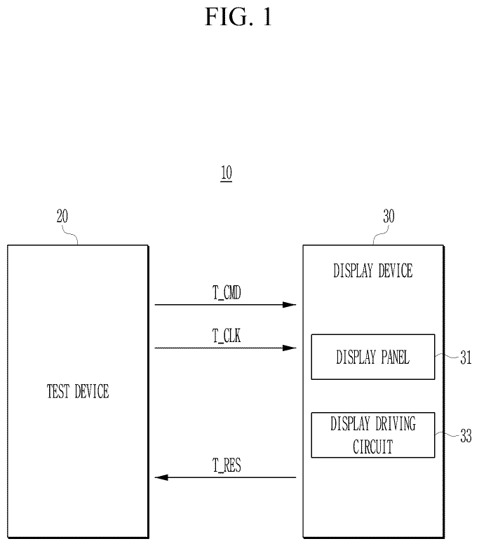

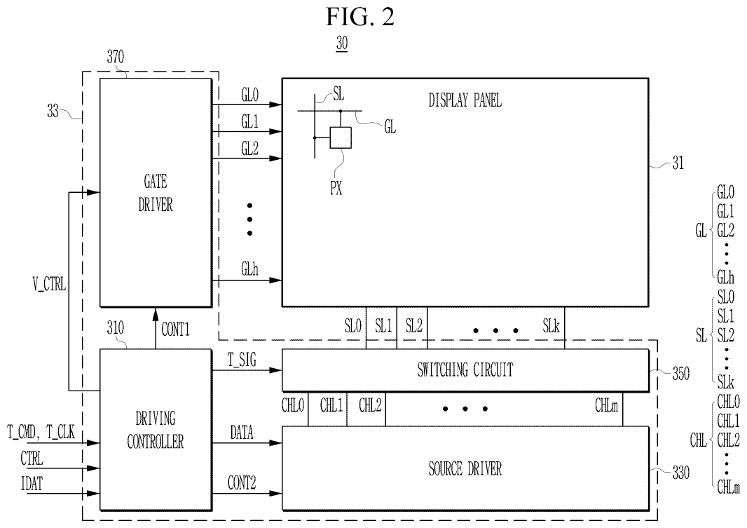

FIG. 1 is a diagram illustrating a display test system. FIG. 2 is a drawing illustrating a display device according to some example embodiments.

As illustrated in FIG. 1, the display test system 10 may include a test device 20 and a display device 30.

A display test system 10 may be a system that tests an operation of a display device 30 using a test device 20.

The test device 20 may generate the plurality of signals for testing the operation of the display device 30. In some example embodiments, the test device 20 may receive a test vector file as input. The test vector file is generated based on environmental information preset for testing the operation of the display device 30, and may include information on signals that may be applied to each port of the display device 30 for testing the operation of the display device 30. The test device 20 may generate a plurality of signals for testing the operation of the display device 30 based on a test vector file. “Environmental information” as used herein may refer to a set of parameters and conditions preset in a simulation environment (e.g., a testbench) to generate the test vector file. For example, the parameters may include IC input information per test cycle, the target switch range, timing conditions, test clock details, and input data patterns, and any other set of inputs and constraints used for performing a simulation.

For example, the test device 20 may generate a test clock T_CLK. The test clock T_CLK may be a clock that serves as a reference for the operation timing when the display device 30 performs a test. In some example embodiments, the test device 20 may transmit a test clock T_CLK to the display device 30. The test device 20 may receive a test result T_RES from the display device 30. The test result T_RES may be an output of the source driver 330 (FIG. 2). The test device 20 may test whether a display driving circuit 33 in the display device 30 operates normally or as designed or intended based on the test result T_RES.

The display device 30 may include a display panel 31 and the display driving circuit 33 for driving the display panel 31.

In some example embodiments, the display device 30 may operate in a display mode for outputting an image to the display panel 31 based on an input image signal received from the outside or in a test mode for testing the operation of the display driving circuit 33. In some example embodiments, when the display device 30 is operating in test mode, the display device 30 may receive a test clock T_CLK from the test device 20. The display device 30 may receive a test command T_CMD from the outside (e.g., from the test device 20). The test command T_CMD may include information about the test target switches. For example, the test command T_CMD may be or include environmental information for the test device 20 to generate a test vector file.

The display device 30 may generate a signal for testing the display driving circuit 33 based on a test command T_CMD and a test clock T_CLK. For example, the display device 30 may test the operation of the plurality of source amplifiers within the source driver 330 when operating in test mode.

Referring to FIG. 2, the display panel 31 may include a plurality of gate lines GL0-GLh (collectively, referred to as a plurality of gate lines GL), a plurality of source lines SL0-SLk (collectively, referred to as a plurality of source lines SL) arranged in a direction intersecting the plurality of gate lines GL, and a plurality of pixels PX arranged in an area where the plurality of gate lines GL and the plurality of source lines SL intersect.

For example, the display device 30 may be a thin film transistor TFT liquid crystal display, and each pixel PX may include a thin film transistor whose gate electrode and source electrode are respectively connected to a gate line and a source line, a liquid crystal capacitor connected to a drain electrode of the thin film transistor, and a storage capacitor. When a specific or desired or given gate line among a plurality of gate lines GL is selected, the thin film transistors of the pixels PX connected to the selected gate line are turned on, and then data voltages may be applied to each of the plurality of source lines SL by the source driver 330. The data voltage is applied to the liquid crystal capacitor and the storage capacitor through the thin film transistor of the corresponding pixel PX, and an image may be displayed by driving the liquid crystal capacitor and the storage capacitor by the data voltage.

In FIG. 2, a pixel PX is illustrated as being connected to one source line SL and one gate line GL, but the connection structure of the signal lines of the pixel PX of the display device according to some example embodiments is not limited thereto. For example, different signal lines may be additionally connected to the circuit structure of the pixel PX.

The display driving circuit 33 may convert an input image signal received from the outside into a plurality of analog signals, for example, a plurality of data voltages, for driving the display panel 31, and provide the converted plurality of analog signals to the display panel 31. In some example embodiments, when the display device 30 operates in a test mode, the display driving circuit 33 may convert a plurality of signals for testing the source driver 330 based on a test command T_CMD and a test clock T_CLK received from the outside, and provide the plurality of converted analog signals to the source driver 330.

The display driving circuit 33 may include a driving controller 310, the source driver 330, a switching circuit 350, and a gate driver 370.

The driving controller 310 may control the overall operation of the display driving circuit 33. For example, the driving controller 310 may generate image data DATA by dividing the input image signal into one frame unit based on a vertical synchronization signal and by dividing the input image signal into the plurality of gate line GL units based on a horizontal synchronization signal.

In some example embodiments, the driving controller 310 may include a gamma voltage generator that generates the plurality of grayscale voltages (or, referred to as gamma voltages).

In some example embodiments, the driving controller 310 may generate output image data DATA having a format that may match the interface specifications with the source driver 330 based on the received input image signal, and output the image data DATA to the source driver 330.

In some example embodiments, the driving controller 310 may control the operating timing of the display driving circuit 33. The driving controller 310 may control the operation timing of the source driver 330, the gate driver 370, and the switching circuit 350 so that the input image signal is displayed on the display panel 31. For example, the driving controller 310 may generate control signals CONT1, CONT2 for controlling the timing of the source driver 330 and the gate driver 370. The driving controller 310 may output a first control signal CONT1 to the gate driver 370 and a second control signal CONT2 to the source driver 330. The first control signal CONT1 may include a control signal that controls the gate level of a plurality of pixels PX. Additionally, the second control signal CONT2 may include an amplifier control signal within the source driver 330, etc.

In some example embodiments, the driving controller 310 may generate a test signal T_SIG to control the switching circuit 350. The test signal T_SIG may be a signal that controls whether a switch in the switching circuit 350 is driven. For example, the test signal T_SIG may be a signal that controls a switch in a switching circuit 350 so that the output of the source driver 330 to be tested is transmitted to the test device 20. In some example embodiments, the driving controller 310 may generate a test signal T_SIG based on a test command T_CMD and a test clock T_CLK.

The source driver 330 may output signals for driving the display panel 31.

The source driver 330 may receive image data DATA in the form of a digital signal from the driving controller 310. For example, image data DATA may be data corresponding to a plurality of pixels PX included in one horizontal line of the display panel 31. In some example embodiments, the image data DATA may include grayscale information corresponding to each pixel PX for displaying the input image signal on the display panel 31. In some example embodiments, the source driver 330 may receive the plurality of grayscale voltages from the driving controller 310. The source driver 330 may convert image data DATA received from the driving controller 310 into a channel signal in the form of an analog signal based on a plurality of grayscale voltages.

The source driver 330 may implement one frame by outputting channel signals to the switching circuit 350 in horizontal line units for each of m+1 channel lines CHL0 to GLm. The source driver 330 may transmit channel signals to the switching circuit 350 based on the second control signal CONT2. The source driver 330 may also be referred to as a data driver.

The source driver 330 may include a plurality of source amplifiers connected to a plurality of channel lines CHL. In some example embodiments, the source amplifier may be an operational amplifier. The source amplifier may amplify the corresponding grayscale voltage. The source amplifier may transmit the amplified voltage as a data voltage (or grayscale voltage) to the switching circuit 350 through the plurality of channel lines CHL0 to CHLm.

The switching circuit 350 is connected to the display panel 31 through k+1 source lines SL0 to SLk and may be connected to the source driver 330 through a plurality of channel lines CHL. For example, the switching circuit 350 may include a plurality of switches connected to each of a plurality of channel lines CHL. Identification data may be assigned to each of the plurality of switches.

In some example embodiments, the switching circuit 350 may include a switch connected between a first channel line among a plurality of channel lines CHL and a second channel line located adjacent or apart from the first channel line. In some example embodiments, the switching circuit 350 may include a switch connected between a plurality of channel lines CHL and a plurality of source lines SL.

The switching circuit 350 may control the operation of the plurality of switches based on a test signal T_SIG. The switching circuit 350 may control the connection between a plurality of channel lines CHL and a plurality of source lines SL by controlling the operation of a plurality of switches. The switching circuit 350 may output the channel signal received from the source driver 330 as a source signal to the display panel 31. The switching circuit 350 may output the channel signal received from the source driver 330 as a test result T_RES to the test device 20.

The gate driver 370 is connected to a plurality of gate lines GL of the display panel 31 and may sequentially drive a plurality of gate lines GL of the display panel 31. The gate driver 370 may provide the plurality of gate signals to the display panel 31. The plurality of gate signals may be pulse signals having enable levels and disable levels. The plurality of gate signals may be applied to the plurality of gate lines GL.

The gate driver 370 may apply the plurality of gate signals to the plurality of gate lines GL in different ways based on the first control signal CONT1. For example, when a gate signal of an enable level is applied to a pixel PX connected to one of a plurality of gate lines GL, a source signal applied to a source line connected to the corresponding pixel PX among a plurality of source lines SL may be transmitted to the pixel PX.

In FIG. 2, the driving controller 310, source driver 330, switching circuit 350, and gate driver 370 are depicted as different functional blocks. In some example embodiments, each configuration may be implemented with a different semiconductor chip. In some example embodiments, at least two components of the driving controller 310, the source driver 330, the switching circuit 350, and the gate driver 370 may be implemented in one (or single) semiconductor chip. For example, the source driver 330, the switching circuit 350, and the gate driver 370 may be integrated into a single semiconductor chip. Additionally, some configurations may be integrated on the display panel 31. For example, the gate driver 370 may be integrated on the display panel 31.

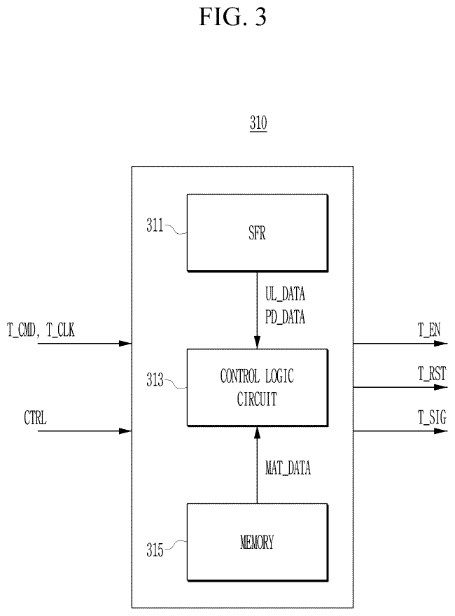

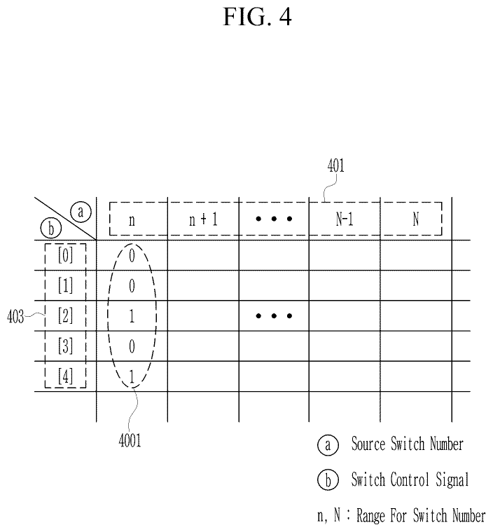

FIG. 3 is a diagram illustrating a driving controller according to some example embodiments. FIG. 4 is a diagram illustrating matching data according to some example embodiments.

As illustrated in FIG. 3, the driving controller 310 may include a special function register SFR 311, a control logic circuit 313, and a memory 315.

The driving controller 310 may receive a test command T_CMD and a test clock T_CLK. The test command T_CMD may include information about or related to the SFR 311 (e.g., the address of the SFR 311) and parameter information. Information about SFR 311 may be information indicating timing conditions for the display device 30 to perform a test. The parameter information may be information indicating the switch range within the switching circuit 350 that is set to perform the test. The parameter information may include identification data indicating a start switch and identification data indicating an end switch among the test target switch range. For example, if the test target switch range is switch number 1 to switch number 7, the parameter information may include ‘1’ as a value indicating the start switch and ‘7’ as a value indicating the end switch.

SFR 311 may store identification data corresponding to the plurality of switches, an amplifier settling period of the plurality of source amplifiers, and a short-circuit prevention period between operations of adjacent source amplifiers of the plurality of source amplifiers. In some example embodiments, the amplifier settling period and short-circuit prevention period may be preset or given based on the period of the test clock T_CLK and the type of source amplifier.

The control logic circuit 313 may read range data UL_DATA corresponding to the test command T_CMD from the identification data stored in the SFR 311 in response to the test command T_CMD. Additionally, the control logic circuit 313 may read period data PD_DATA corresponding to the test command T_CMD from the amplifier settling period of the plurality of source amplifiers and the short-circuit prevention period between the plurality of source amplifiers stored in the SFR 311. For example, the control logic circuit 313 may read out period data PD_DATA based on information about the SFR 311 and read out range data UL_DATA based on parameter information.

The range data UL_DATA may include identification data indicating at least one switch included in the test target switch range. For example, the range data UL_DATA may include identification data indicating a start switch, identification data indicating an end switch, and identification data indicating at least one intermediate switch between the start switch and the end switch. The control logic circuit 313 may read range data UL_DATA in which a plurality of identification data are sequentially listed according to size from the SFR 311 based on parameter information.

The period data PD_DATA may include an amplifier settling period and a short-circuit prevention period to be applied by the display device 30 during test operation.

The amplifier settling period may be the time required for the source amplifier within the source driver 330 to settle the channel signal. For example, the source amplifier may generate a channel signal that varies based on variations in image data DATA. At this time, the source amplifier may take a certain period of time to generate a stable channel signal such that a fluctuation range of the channel signal converges within a preset error range. The amplifier settling period may refer to the period from the time when the image data DATA begins to fluctuate to the time when the output of the source amplifier reaches a stable state. In some example embodiments, the amplifier settling period may be the minimum period of time during which each of the test target switches maintains a turn on state.

The short-circuit prevention period may be a time period to prevent or reduce or limit signal interference or short-circuit between adjacent source amplifiers when the plurality of source amplifiers are driven sequentially. For example, when a first source amplifier, a second source amplifier, and a third source amplifier operate sequentially, at the point where the operation of the first source amplifier ends and the operation of the second source amplifier begins, or at the point where the operation of the second source amplifier ends and the operation of the third source amplifier begins, if an operation period of the source amplifiers overlaps, a short circuit of a signal between the source amplifiers may occur. Accordingly, the short-circuit prevention period may be the period (e.g., a minimum period) during which the operating periods of the source amplifiers (e.g., of immediately adjacent source amplifiers) do not overlap. In some example embodiments, the short-circuit prevention period may be a period of time after any test target switch among the plurality of test target switches is turned off until a next switch to be tested is turned on. For example, the short-circuit prevention period may be set between periods in which adjacent switches among the plurality of test target switches are turned on.

Memory 315 may store matching data MAT_DATA. Matching data MAT_DATA may store switch control signals that control each switch in response to switch identification data. Referring to FIG. 4, matching data MAT_DATA may be a table that stores a switch control signal 403 that controls a plurality of target switches corresponding to a switch range 401.

As illustrated in FIG. 4, the matching table may include a switch control signal 403 matched according to a switch range 401 corresponding to range data UL_DATA. The switch range 401 may be sequential data that sequentially lists the identification data of the test target switch according to size of the sequential data.

The switch control signal 403 may be composed of a set of bits that control each of a plurality of switches. The number of bits of the switch control signal 403 may be determined based on the number of switches of the switching circuit 350.

For example, a switch control signal 4001 for controlling the plurality of switches corresponding to the first switch n, which is a start switch, may have a value of ‘10100’, which lists values corresponding to binary numbers [4], [3], [2], [1], and [0], respectively. Hereinafter, for each bit of the switch control signal, the most significant bit MSB is defined as the first bit, and sequentially referred to as the second bit, third bit, . . . , and least significant bit LSB. The switch corresponding to the first bit may be controlled based on the value of ‘1’, the switch corresponding to the second bit may be controlled based on the value of ‘0’, the switch corresponding to the third bit may be controlled based on the value of ‘1’, and the switches corresponding to the fourth bit and the fifth bit LSB may each be controlled based on the value of ‘0’. If the switch control signal has ‘1’, the switch may be short-circuited or closed, and if it has ‘0’, the switch may be opened. The switch control signal corresponding to the first switch n may short-circuit the switch corresponding to the MSB and the switch corresponding to the third bit, and open the remaining switches.

In FIG. 4, it is described assuming that the most significant bit of the switch control signal is a bit corresponding to the value 2⁴, but example embodiments are not limited thereto.

Referring again to FIG. 3, the control logic circuit 313 may generate a test signal T_SIG, a test enable signal T_EN, and a test reset signal T_RST based on information stored in the SFR 311 and information stored in the memory 315. For example, the control logic circuit 313 may read out range data UL_DATA and period data PD_DATA based on a test command T_CMD and a test clock T_CLK, read out matching data MAT_DATA based on the range data UL_DATA, and generate a test signal T_SIG based on the matching data MAT_DATA. The test signal T_SIG may be a set of switch control signals for controlling a switch corresponding to each of a plurality of identification data within the range data UL_DATA.

In some example embodiments, the control logic circuit 313 may include flip-flops and/or counters that operate synchronously based on or in response to a test clock T_CLK. The control logic circuit 313 may generate a test signal T_SIG using a flip-flop and/or a counter.

For example, the control logic circuit 313 may initialize a counter based on identification data corresponding to the start switch, and then increase the counter value by 1 in synchronization with the rising edge or falling edge of the test clock T_CLK. Thereafter, the control logic circuit 313 may sequentially generate a test signal T_SIG for the switch corresponding to each counter output value until the current value of the counter matches the identification data corresponding to the end switch.

For example, the control logic circuit 313 may control the amplifier settling period and the short-circuit prevention period (for example, non-overlap period) based on the test clock T_CLK. The control logic circuit 313 may count a predetermined number of clock cycles after a switch is turned on to secure an amplifier settling period, and subsequently control the next switch to turn off. The control logic circuit 313 may control an adjacent switch to turn on after (or only after) securing a short-circuit prevention period following the turn-off of the previous switch, in order to prevent or limit a short-circuit during the control interval between adjacent switches.

The test enable signal T_EN may be a signal that indicates the start of a test in response to receiving a test command T_CMD. In some example embodiments, the control logic circuit 313 may generate a test enable signal T_EN and generate a test signal T_SIG after an initial period. For example, the initial period may be preset based on the test clock T_CLK.

The test reset signal T_RST may be a signal indicating the end of the test. In some example embodiments, the control logic circuit 313 may generate a test reset signal T_RST upon the termination of the test signal T_SIG.

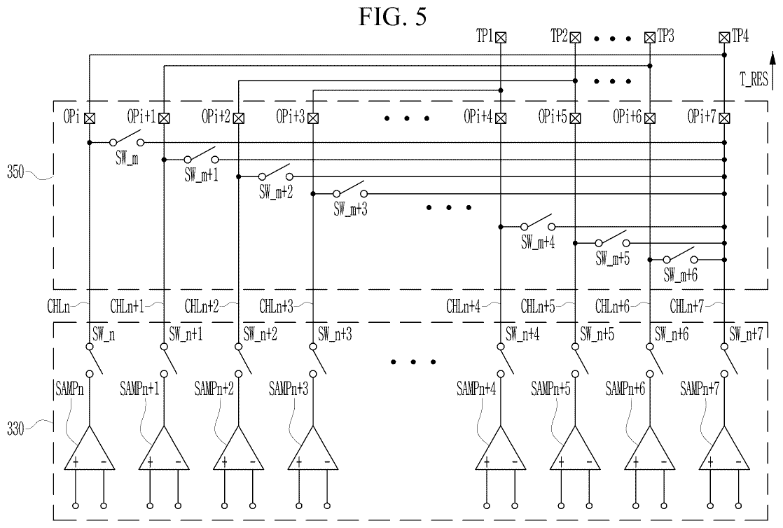

FIG. 5 is a diagram illustrating a part of a display device according to some example embodiments.

FIG. 5 is a diagram illustrating a switching circuit 350 and a source driver 330 according to some example embodiments.

The source driver 330 may include a plurality of source amplifiers SAMPn to SAMPn+7 respectively connected to a plurality of channel lines CHLn to CHLn+7. The output terminal of each source amplifier SAMPn to SAMPn+7 may be connected to a corresponding output switch SW_n to SW_n+7. A plurality of source amplifiers SAMPn to SAMPn+7 may generate channel signals based on corresponding image data DATA. For example, the n-th source amplifier SAMPn may generate a channel signal based on input data and output the channel signal to a channel line CHLn through a corresponding output switch SW_n.

The switching circuit 350 may control the output path of the channel signals of the source driver 330. The switching circuit 350 may include a plurality of connection switches SW_m to SW_m+6 and a plurality of output pads OPi to OPi+7. Each of a plurality of connection switches SW_m to SW_m+6 may be connected between the output switch SW_n+7 and a corresponding one of the output switches SW_n to SW_n+6. For example, a first end of a connection switch SW_m may be connected to an output switch SW_n and a second end of the connection switch SW_m may be connected to an output switch SW_n+7. A first end of the connection switch SW_m+1 may be connected to the output switch SW_n+1 and a second end of the connection switch SW_m+1 may be connected to the output switch SW_n+7. Each of a plurality of output switches SW_n to SW_n+7 has one end connected to an output terminal of a corresponding source amplifier SAMPn to SAMPn+7, and the other end connected to a corresponding output pad OPi to OPi+7.

Each of the plurality of connection switches SW_m to SW_m+6 and the plurality of output switches SW_n to SW_n+7 may be controlled based on a test signal T_SIG generated by the control logic circuit 313. The driving controller 310 may control the output path of the output of the plurality of source amplifiers SAMPn to SAMPn+7 using a test signal T_SIG.

The plurality of output pads OPi to OPi+7 may be connected to test pads TP1 to TP4 of the test device 20.

The display device 30 may have different package types based on the location where the display driving circuit 33 is disposed. In some example embodiments, when the display device 30 has a Chip on Glass structure (COG) in which the display driving circuit 33 is disposed on a glass substrate, the display device 30 may control the path of the output signal of the source amplifier SAMPn to SAMPn+7 by selectively controlling the connection of each of the plurality of connection switches SW_m to SW_m+6.

In some example embodiments, when the display device 30 has a Chip on Film (COF) structure in which the display driving circuit 33 is disposed on a flexible film, the display device 30 may control the path of the output signal of the source amplifier SAMPn to SAMPn+7 by selectively controlling the connection of each of the plurality of output switches SW_n to SW_n+7.

In some example embodiments, each of the plurality of connection switches SW_m to SW_m+6 and the plurality of output switches SW_n to SW_n+7 may be assigned different identification data. Since different identification data is assigned to the plurality of connection switches SW_m to SW_m+6 and the plurality of output switches SW_n to SW_n+7, the display device 30 may individually control the plurality of connection switches SW_m to SW_m+6 and the plurality of output switches SW_n to SW_n+7, and may perform a test operation regardless of the package type of the display device 30.

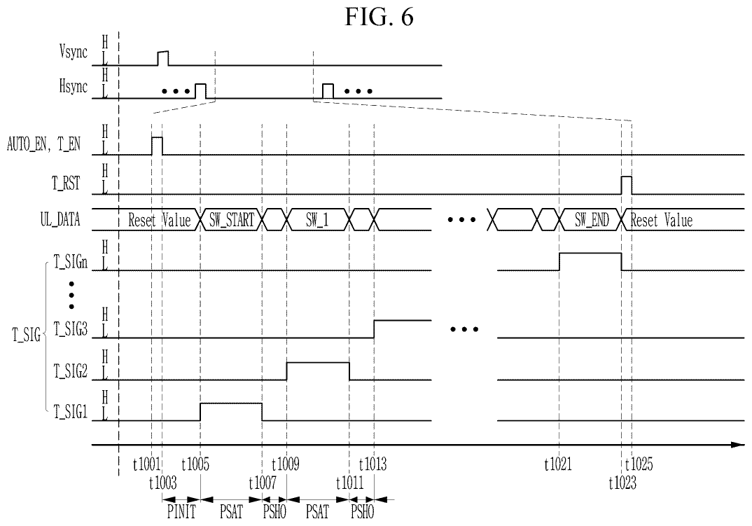

FIG. 6 is a diagram illustrating the operation timing of a display device according to some example embodiments.

First, the display device 30 may generate image data DATA by dividing the image signal into one frame unit based on a vertical synchronization signal Vsync and by dividing the image signal into gate line GL in FIG. 1 units based on a horizontal synchronization signal Hsync.

The pulse period of the vertical synchronization signal Vsync may be one frame period according to the display frame rate. The vertical blank period may be the period during which the vertical synchronization signal Vsync is at a low level L.

The source driver 330 may apply data signals to the plurality of source lines SL in synchronization with a horizontal synchronization signal Hsync. For example, the source driver 330 may apply a data signal to the plurality of source lines SL in a section where the horizontal synchronization signal Hsync is at a high level H. The horizontal blank period may be a period during which the horizontal synchronization signal Hsync is at a low level L. The active period may be any period within a horizontal period, excluding the horizontal blank period. A single frame period may include the plurality of horizontal blank periods and the plurality of active periods.

Within the horizontal blank period, the source driver 330 may operate in test mode.

First, at time t1001, the test enable signal T_EN may transition from a low level L to a high level H.

At time t1003, the test enable signal T_EN may transition from a high level H to a low level L.

The control logic circuit 313 may perform a test after a preset initial period PINIT from the time when the test enable signal T_EN is at a low level L. For example, the initial period PINIT may be a period set by the test device 20 based on the test clock T_CLK.

During the initial period PINIT, the control logic circuit 313 may read period data PD_DATA and range data UL_DATA from the SFR 311. Range data UL_DATA may include data for the start switch and end switch within the test target switch range. The range data UL_DATA may include identification data corresponding to the reset value, which precedes the identification data for the start switch and follows the identification data for the end switch. The reset value may be any value that does not correspond to any switch.

In FIG. 6, for convenience of explanation, identification data corresponding to each point in time within the range data UL_DATA is shown over time. However, the range data UL_DATA may not include data that varies over time, but may be fixed (or unchanged or non-variable) data that includes identification data indicating a start switch, identification data indicating an intermediate switch, identification data indicating an end switch, and identification data indicating reset values before the start switch and after the end switch.

At time t1005, the first test signal T_SIG1 may transition from a low level L to a high level H. At time t1007, the first test signal T_SIG1 may transition from a high level H to a low level L.

The control logic circuit 313 may generate a first test signal T_SIG1 based on period data PD_DATA and range data UL_DATA. The control logic circuit 313 may read out a switch control signal corresponding to the start switch SW_START based on matching data MAT_DATA stored in the memory 315. The control logic circuit 313 may generate a switch control signal as a first test signal T_SIG1 for controlling the start switch SW_START. The first test signal T_SIG1 may maintain a high level H during the amplifier settling period PSAT from time t1005 to time t1007.

Time t1007 to time t1009 may correspond to the short-circuit prevention period PSHO.

At time t1009, the second test signal T_SIG2 may transition from a low level L to a high level H. At time t1011, the second test signal T_SIG2 may transition from a high level H to a low level L.

The control logic circuit 313 may generate a second test signal T_SIG2 based on the period data PD_DATA and the range data UL_DATA. The control logic circuit 313 may read out a switch control signal corresponding to the first switch SW_1 that is the next switch in the sequence after the start switch SW_START based on the matching data MAT_DATA stored in the memory 315. The control logic circuit 313 may generate a switch control signal as a second test signal T_SIG2 for controlling the first switch SW_1. The second test signal T_SIG2 may maintain a high level H during the amplifier settling period PSAT from t1009 to t1011.

Time t1011 to time t1013 may correspond to the short-circuit prevention period PSHO.

Thereafter, the control logic circuit 313 may generate a test signal T_SIG1 based on the period data PD_DATA and the range data UL_DATA. For example, the control logic circuit 313 may generate a test signal according to the order of identification data included in the range data UL_DATA. Accordingly, the control logic circuit 313 may test the plurality of switches in a predetermined order and may sequentially control each of the plurality of switches.

At time t1021, the n-th test signal T_SIGn may transition from a low level L to a high level H.

The control logic circuit 313 may generate the n-th test signal T_SIGn based on the period data PD_DATA and the range data UL_DATA. The control logic circuit 313 may read out a switch control signal corresponding to the end switch SW_END based on matching data MAT_DATA stored in the memory 315. The control logic circuit 313 may generate a switch control signal as a test signal T_SIGn for controlling the end switch SW_END. The n-th test signal T_SIGn may maintain a high level H during the amplifier settling period PSAT from time t1021 to time t1023.

At time t1023, the n-th test signal T_SIGn may transition from a high level H to a low level L. Additionally, the test reset signal T_RST may transition from a low level L to a high level H.

The control logic circuit 313 may terminate the test from the point in time when the test reset signal T_RST is at a high level H. The control logic circuit 313 may reset the values of internal flip-flops and/or counters. At this time, the range data UL_DATA may include identification data corresponding to the reset value.

At time t1025, the test reset signal T_RST may transition from a high level H to a low level L.

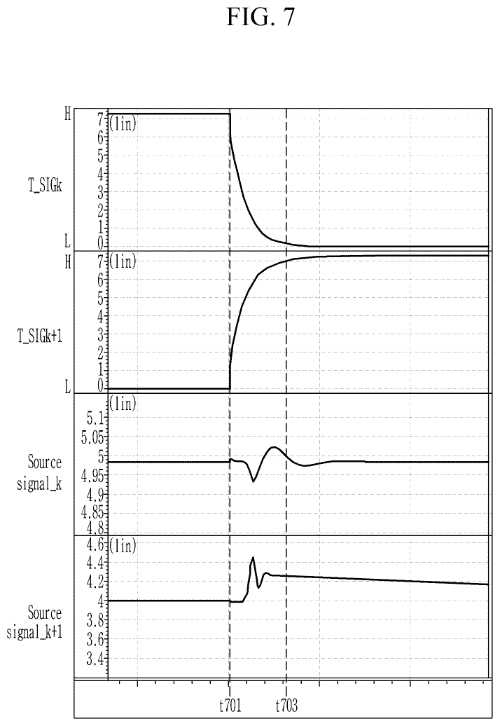

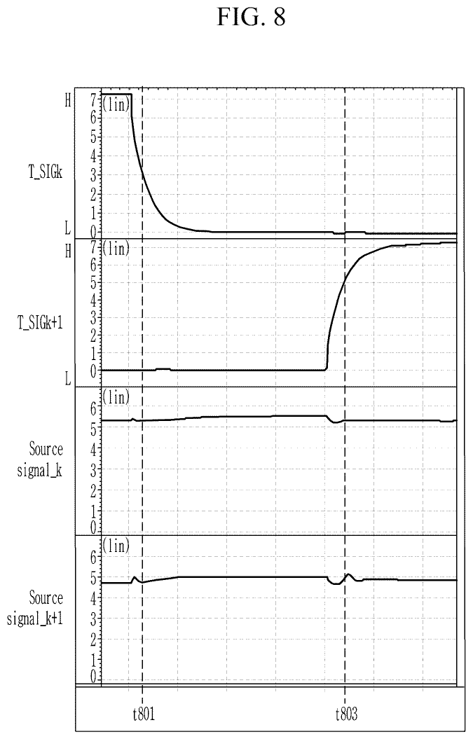

FIGS. 7 and 8 are diagrams illustrating the output signal of the source amplifier according to the operation of the output switch.

FIG. 7 is a diagram illustrating the output signal of the source amplifier when the short-circuit prevention period is not set. FIG. 8 is a diagram illustrating an output signal of a source amplifier when a short-circuit prevention period is set according to some example embodiments.

The kth output switch SW_k and the k+1th switch SW_k+1 may operate sequentially. As illustrated in FIG. 7, the kth test signal T_SIGk controlling the kth switch SW_k at t701 may transition from a high level H to a low level L, and the k+1th test signal T_SIGk+1 controlling the k+1th switch SW_k+1 may transition from a low level L to a high level H.

As the k-th test signal T_SIGk and the k+1-th test signal T_SIGk+1 transition simultaneously, overlap may occur between the k-th output signal output through the k-th switch SW_k and the k+1-th output signal output through the k+1-th switch SW_k+1. At t703, the kth output signal and the k+1th output signal may be stabilized. In t701 to t703, short circuit and overcurrent may occur due to overlap between output signals.

As illustrated in FIG. 8, at t801, the kth test signal T_SIGk controlling the kth switch SW_k may transition from a high level H to a low level L, and at t803, the k+1th test signal T_SIGk+1 controlling the k+1th switch SW_k+1 may transition from a low level L to a high level H.

As the k-th test signal T_SIGk and the k+1-th test signal T_SIGk+1 transition at different times, the k+1-th output signal output through the k+1-th switch SW_k+1 may be generated after the k-th output signal output through the k-th switch SW_k is stabilized. Accordingly, overlap between the kth output signal and the k+1th output signal may not occur.

A display device 30 according to some example embodiments may prevent or limit or reduce overlapping between output signals by appropriately setting a short-circuit prevention period.

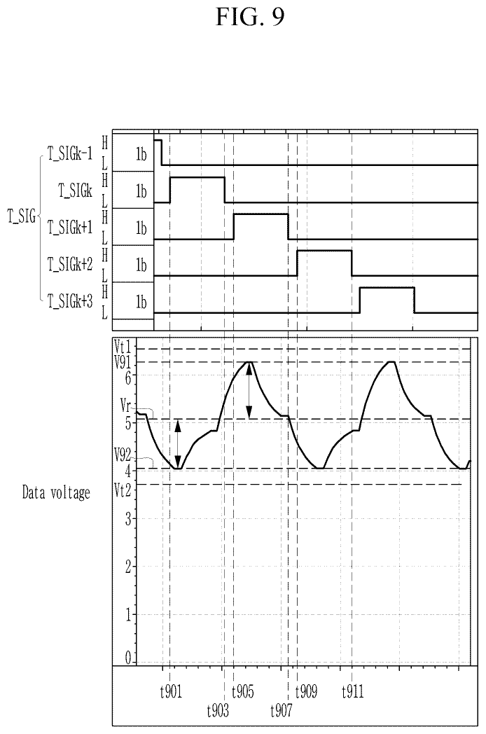

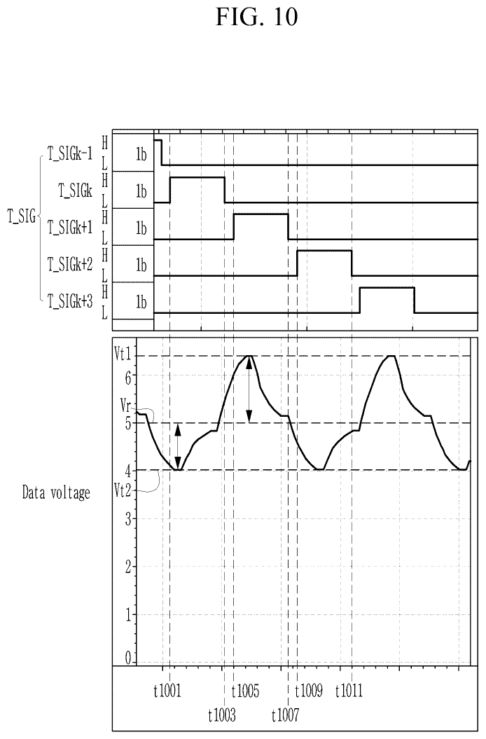

FIGS. 9 and 10 are diagrams illustrating data voltage according to the operation of the output switch.

FIG. 9 is a diagram illustrating the output signal of the source amplifier when the amplifier settling period is not set.

At time t901, the k test signal T_SIGk may transition from a low level L to a high level H. The k switch is turned on by the k test signal T_SIGk of the high level H, and the data voltage may increase from the second level V92 to the reference level Vr by the k output signal output through the k switch.

At time t903, the k test signal T_SIGk may transition from a high level H to a low level L.

At time t905, the k+1 test signal T_SIGk+1 may transition from a low level L to a high level H. The k+1 switch is turned on by the k+1 test signal T_SIGk+1 of the high level H, and the data voltage may increase to the first level V91 by the k+1 output signal output through the k+1 switch. However, since the period during which the k+1 test signal T_SIGk+1 of the high level H is maintained is relatively shorter, the data voltage cannot increase to the first target voltage Vt1.

At time t907, the k+1 test signal T_SIGk+1 may transition from a high level H to a low level L.

At time t909, the k+2 test signal T_SIGk+2 may transition from a low level L to a high level H. The k+2 switch is turned on by the k+2 test signal T_SIGk+2 of the high level H, and the data voltage may be reduced from the first level V91 to the second level V92 by the k+2 output signal output through the k+2 switch. However, since the period during which the k+2 test signal T_SIGk+2 of the high level H is maintained is relatively shorter, the data voltage cannot decrease to the second target voltage Vt2.

At time t911, the k+2 test signal T_SIGk+2 may transition from a high level H to a low level L.

FIG. 10 is a diagram illustrating an output signal of a source amplifier when an amplifier settling period is set according to some example embodiments.

At time t1001, the k test signal T_SIGk may transition from a low level L to a high level H. The k switch is turned on by the k test signal T_SIGk of the high level H, and the data voltage may increase from the second level V102 to the reference level Vr by the k output signal output through the k switch.

At time t1003, the k test signal T_SIGk may transition from a high level H to a low level L.

At time t1005, the k+1 test signal T_SIGk+1 may transition from a low level L to a high level H. The k+1 switch is turned on by the k+1 test signal T_SIGk+1 of the high level H, and the data voltage may increase to the first target voltage Vt1 by the k+1 output signal output through the k+1 switch. However, since the period during which the k+1 test signal T_SIGk+1 of the high level H is maintained is relatively longer, the data voltage may increase to the first target voltage Vt1.

At time t1007, the k+1 test signal T_SIGk+1 may transition from a high level H to a low level L.

At time t1009, the k+2 test signal T_SIGk+2 may transition from a low level L to a high level H. The k+2 switch is turned on by the k+2 test signal T_SIGk+2 of the high level H, and the data voltage may be reduced from the first target voltage Vt1 to the second level V92 by the k+2 output signal output through the k+2 switch. However, since the period during which the k+2 test signal T_SIGk+2 of the high level H is maintained relatively longer, the data voltage may decrease to the second target voltage Vt2.

At time t1011, the k+2 test signal T_SIGk+2 may transition from a high level H to a low level L.

A display device 30 according to some example embodiments may control the data voltage to reach the target voltage by appropriately setting the amplifier settling period.

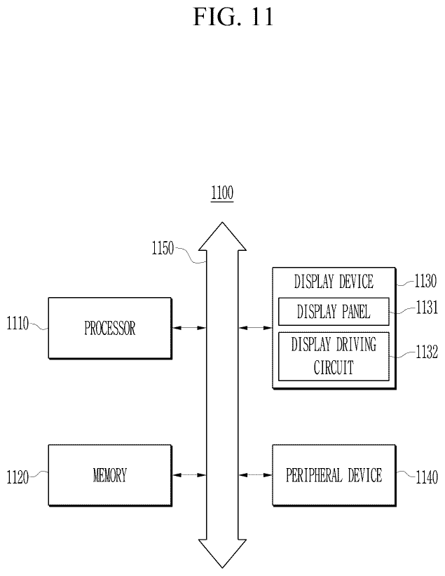

FIG. 11 is a diagram illustrating a display system according to some example embodiments.

Referring to FIG. 11, a display system 1100 according to some example embodiments may include a processor 1110, a memory 1120, a display device 1130, and a peripheral device 1140 electrically connected to a system bus 1150.

The processor 1110 controls the input/output of data from the memory 1120, the display device 1130, and the peripheral device 1140, and may perform image processing of image data transmitted between the devices. The display device 1130 may be the display device 30 of FIG. 1, and may include a display panel 1131 (similar to the display panel 31) that displays an image (still and/or moving images) and a display driving circuit 1132 (similar to the display driving circuit 33).

The memory 1120 may include volatile memory such as DRAM (Dynamic Random Access Memory) and/or non-volatile memory such as flash memory. The memory 1120 may be DRAM, PRAM (Phase-change Random Access Memory), MRAM (Magnetic Random Access Memory), ReRAM (Resistive Random Access Memory), FRAM (Ferroelectric Random Access Memory), NOR flash memory, NAND flash memory, and fusion flash memory (e.g., memory in which a SRAM (Static Random Access Memory) buffer, NAND flash memory, and NOR interface logic are combined). The memory 1120 may store image data obtained from a peripheral device 1140 or an image signal processed by the processor 1110.

Conventionally, a plurality of test pins of a test device and output pins formed on a source driver of a display device were respectively connected, and signals output from each output pin were received through the test device to test an operation of the source driver. The display device 30, according to some example embodiments, does not receive a signal through an individual test pin from the test device 20, but receives a test command, and the display device 30 generates a test signal for performing a test based on the received test command to perform a test on the source driver. Accordingly, the size of the display driving circuit 33 may be reduced, and the test execution time may be shortened. In addition, by controlling an operation of each of a plurality of switches in the display device 30, a test on the source driver can be performed even if a connection structure of the plurality of switches is different depending on a package type of the display device 30.

The peripheral device 1140 may be a device that converts video or still images into electrical signals, such as a camera, scanner, or webcam. Image data acquired through a peripheral device 1140 may be stored in memory 1120 or displayed on a display panel 1131 in real time.

The display system 1100 may be used in a mobile electronic product such as a smartphone, but is not limited thereto, and the display system 1100 may be used in any electronic device that display images.

According to some example embodiments, a method of operating a display device includes receiving a test command including parameter information indicating a test target switch range and timing conditions to perform a test of the display device; generating a test signal that is configured to control a plurality of switches of the display device based on the test command, wherein the display device includes a plurality of connection switches connected to a plurality of source amplifiers that are configured to generate channel signals; and outputting the channel signals as a test result. According to some example embodiments, the display device includes a plurality of output switches connected to the plurality of source amplifiers, and the method further comprises receiving the test command including the parameter information indicating the test target switch range of the plurality of output switches and the plurality of connection switches; and generating a test signal to control the plurality of output switches and the plurality of connection switches based on the test command. According to some example embodiments, each output switch of the plurality of output switches includes a first end connected to an output terminal of a corresponding source amplifier of the plurality of source amplifiers, and a second end connected to a first end of a corresponding connection switch of the plurality of connection switches. According to some example embodiments, the method further comprises receiving range data based on the parameter information and identification data corresponding to the plurality of output switches and the plurality of connection switches. The parameter information includes first identification data indicating a start switch and second identification data indicating an end switch, and the range data includes sequential data, the sequential data includes a sequential listing of the first identification data, the second identification data, and third identification data indicating at least one intermediate switch between the start switch and the end switch, and the first identification data, the second identification data, and the third identification data are sequentially listed based on size. The method further comprises receiving matching data including a switch control signal that is matched corresponding to the identification data; and receiving a plurality of switch control signals corresponding to the first identification data, the second identification data, and the third identification data based on the matching data.

According to some example embodiments, a method of operating a test system includes generating, using a test device, a test command including parameter information indicating a test target switch range and timing conditions to perform a test; receiving, using a display device, the test command and generating a test signal based on the test command; controlling a plurality of switches of the display device in response to the test signal; generating, using the display device, channel signals in response to the test signal; and outputting, by the display device, a test result based on the channel signals, the test result determining an operation of the display device. According to some example embodiments, the plurality of switches includes a plurality of output switches connected to a plurality of source amplifiers and a plurality of connection switches connected to the plurality of output switches, and the method further includes receiving the test command including the parameter information indicating the test target switch range of the plurality of output switches and the plurality of connection switches; and generating the test signal to control the plurality of output switches and the plurality of connection switches based on the test command. According to some example embodiments, each output switch of the plurality of output switches includes a first end connected to an output terminal of a corresponding source amplifier of the plurality of source amplifiers, and a second end connected to a first end of a corresponding connection switch of the plurality of connection switches. According to some example embodiments, the method further includes receiving range data based on the parameter information and identification data corresponding to the plurality of output switches and the plurality of connection switches. The parameter information includes first identification data indicating a start switch and second identification data indicating an end switch, and the range data includes sequential data, the sequential data includes a sequential listing of the first identification data, the second identification data, and third identification data indicating at least one intermediate switch between the start switch and the end switch, and the first identification data, the second identification data, and the third identification data are sequentially listed based on size. The method also includes receiving matching data including a switch control signal that is matched corresponding to the identification data; and receiving a plurality of switch control signals corresponding to the first identification data, the second identification data, and the third identification data based on the matching data.

As described herein, any devices, systems, modules, portions, units, controllers, circuits, and/or portions thereof according to any of the example embodiments, and/or any portions thereof (including, without limitation, the test device 20, the display device 30, the display panel 31, the display driving circuit 33, the driving controller 310, the source driver 330, the switching circuit 350, the gate driver 370, the special function register SFR 311, the control logic circuit 313, the memory 315, the processor 1110, the memory 1120, the display device 1130, the peripheral device 1140, the display panel 1131, the display driving circuit 1132, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), a System-on-Chip (SoC), a programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A display driving circuit comprising:
a source driver comprising a plurality of source amplifiers configured to generate channel signals;
a switching circuit including a plurality of switches and connected to the source driver, the plurality of switches being configured to output the channel signals as a test result; and
a driving controller configured to receive a test command including parameter information indicating a test target switch range among the plurality of switches and timing conditions to perform a test, and generate a test signal that is configured to control the plurality of switches based on the test command.

2. The display driving circuit of claim 1, the driving controller comprises:
a Special Function Register (SFR) configured to store a plurality of identification data corresponding to the plurality of switches; and
a control logic circuit configured to read range data based on the parameter information and the plurality of identification data,
wherein the parameter information includes first identification data indicating a start switch and second identification data indicating an end switch, and the range data includes sequential data, the sequential data includes a sequential listing of the first identification data, the second identification data, and third identification data indicating at least one intermediate switch between the start switch and the end switch, and the first identification data, the second identification data, and the third identification data are sequentially listed based on size.

3. The display driving circuit of claim 2, wherein
the SFR is configured to store an amplifier settling period of the plurality of source amplifiers and a short-circuit prevention period between operations of the plurality of source amplifiers, and
the control logic circuit is configured to read period data based on the timing conditions, the amplifier settling period, and the short-circuit prevention period.

4. The display driving circuit of claim 3, wherein
the driving controller includes a memory configured to store matching data including a switch control signal matched corresponding to the plurality of identification data, wherein the switch control signal includes a set of bits that control each switch of the plurality of switches, and
the control logic circuit is configured to read out a plurality of switch control signals corresponding to the first identification data, the second identification data, and the third identification data within the range data based on the matching data, and generate the test signal based on the period data, the test signal including a set of the plurality of switch control signals.

5. The display driving circuit of claim 4, wherein
the test signal includes a first switch control signal configured to control the start switch, a second switch control signal configured to control the end switch, and a third switch control signal configured to control the at least one intermediate switch, and
each of the start switch, the end switch, and the at least one intermediate switch are turned on during the amplifier settling period.

6. The display driving circuit of claim 5, wherein
the short-circuit prevention period is set between adjacent time periods including a first time period in which the start switch is turned on, a second time period in which the end switch is turned on, and at least one third time period in which the at least one intermediate switch is turned on.

7. The display driving circuit of claim 2, wherein
the source driver further comprises a plurality of connection switches,
the plurality of switches of the switching circuit include a plurality of output switches, and
each of the plurality of output switches includes a first end connected to an output terminal of a corresponding source amplifier of the plurality of source amplifiers, and a second end connected to a corresponding connection switch of the plurality of connection switches.

8. The display driving circuit of claim 7, wherein
a first end of a first output switch of the plurality of output switches is connected to an output terminal of a first source amplifier of the plurality of source amplifiers and a second end of the first output switch is connected to a first end of a first connection switch of the plurality of connection switches, and
a first end of a second output switch of the plurality of output switches is connected to an output terminal of a second source amplifier of the plurality of source amplifiers and a second end of the second output switch is connected to a second end of the first connection switch.

9. The display driving circuit of claim 8, wherein
the control logic circuit is configured to control the plurality of connection switches to test a display device, the display device having a Chip on Glass (COG) structure.

10. The display driving circuit of claim 8, wherein
the control logic circuit is configured to control the plurality of output switches to test a display device, the display device having a Chip on Film (COF) structure.

11. The display driving circuit of claim 3, wherein
the amplifier settling period is a period during which a fluctuation range of a channel signal converges within a preset error range, and
the short-circuit prevention period is a period to limit short-circuit between adjacent source amplifiers of the plurality of source amplifiers.

12. The display driving circuit of claim 3, wherein
the driving controller is configured to receive a test clock, and
the amplifier settling period and the short-circuit prevention period are set based on the test clock.

13. The display driving circuit of claim 1, wherein
the driving controller is configured to generate a test enable signal to indicate a start of a test and a test reset signal to indicate an end of the test in response to receiving the test command.

14. A display device comprising:
a source driver comprising a plurality of output switches and a plurality of source amplifiers configured to generate channel signals;
a switching circuit including a plurality of connection switches, and connected to the source driver that is configured to output the channel signals as a test result, each output switch of the plurality of output switches includes a first end connected to an output terminal of a corresponding source amplifier of the plurality of source amplifiers, and a second end connected to a first end of a corresponding connection switch of the plurality of connection switches; and
a driving controller configured to receive a test command including parameter information indicating a test target switch range of the plurality of output switches and the plurality of connection switches, and timing conditions to perform a test, and generate a test signal to control the plurality of output switches and the plurality of connection switches based on the test command.

15. The display device of claim 14, wherein
the driving controller is configured to control the plurality of connection switches and the plurality of output switches to perform a test on the source driver wherein the driving controller is configured to control the plurality of connection switches and the plurality of output switches based on a package type of the display device.

16. A test system comprising:
a test device configured to generate a test clock; and
a display device configured to receive the test clock and configured to use the test clock as a reference for operating timing when the display device performs a test, the display device including a plurality of switches connected to a plurality of source amplifiers that are configured to generate channel signals, and the display device being configured to receive a test command including parameter information indicating a test target switch range and timing conditions to perform the test, generate a test signal that is configured to control the plurality of switches based on the test command, and output the channel signals as a test result.

17. The test system of claim 16, wherein the display device includes,
a Special Function Register (SFR) configured to store a plurality of identification data corresponding to the plurality of switches;
a control logic circuit configured to read range data based on the parameter information and the plurality of identification data; and
a memory configured to store matching data, wherein
the matching data includes a switch control signal that is matched corresponding to the plurality of identification data, and
the switch control signal includes a set of bits that control each switch of the plurality of switches.

18. The test system of claim 17, wherein
the parameter information includes first identification data indicating a start switch and second identification data indicating an end switch, and the range data includes sequential data, the sequential data includes a sequential listing of the first identification data, the second identification data, and third identification data indicating at least one intermediate switch between the start switch and the end switch, and the first identification data, the second identification data, and the third identification data are sequentially listed based on size, and
the control logic circuit is configured to read a plurality of switch control signals corresponding to the first identification data, the second identification data, and the third identification data based on the matching data.

19. The test system of claim 18, wherein the SFR is configured to store an amplifier settling period of the plurality of source amplifiers and a short-circuit prevention period between operations of the plurality of source amplifiers,
the control logic circuit is configured to read period data based on the test clock, the timing conditions, the amplifier settling period, and the short-circuit prevention period, and generate the test signal based on the period data, the test signal including a set of the plurality of switch control signals.

20. The test system of claim 16, wherein
the plurality of switches includes a plurality of output switches and a plurality of connection switches,
each output switch of the plurality of output switches includes a first end connected to an output terminal of a corresponding source amplifier of the plurality of source amplifiers, and a second end connected to a corresponding connection switch of the plurality of connection switches.
